(19) United States
(12) Patent Application Publication
(10) Pub. No.: US 2003/0135407 A1
(43) Pub. Date: Jul. 17, 2003

(54) Parking meter system

(76) Inventors: Sydney James Reinhardt, New South Wales (AU); Geoffrey David Sizer, New South Wales (AU); Michael David Kroon, New South Wales (AU); Jan Szymanski, New South Wales (AU)

Correspondence Address: LADAS & PARRY, 26 WEST 61ST STREET, NEW YORK, NY, 10023, US

(21) Appl. No.: 10/221,462

(22) PCT Filed: Mar. 14, 2001
(86) PCT No.: PCT/AU01/00274

(51) Int. Cl. G06F 17/60

(52) U.S. Cl. 705/13; 705/30

(57) ABSTRACT

A system adapted for robust storage of parking meter information in a parking meter system is disclosed. The system comprises a plurality of cash boxes (106) and a corresponding plurality of parking meters (108), wherein the cash boxes (106) are periodically and substantially randomly, (i) mated with the corresponding plurality of parking meters (108) for a collection period, and (ii) subsequently collected from said corresponding plurality of parking meters (108). The system comprises parking meter storage means (102) for storing by each parking meter (108) (i) current information relating to a current collection period and (ii) historic information relating to a number of previous collection periods into each cash box (106) which is successively mated with said each parking meter (108), retrieval means (118) for retrieving all information carried by said each cash box (106) after removal of said each cash box (106) from a corresponding parking meter (108) and storage means (134) for storing said all information into a system data store, thereby to perform repetitive and thus robust storage of individual information records.

### TECHNICAL FIELD OF THE INVENTION

The present invention relates generally to the field of parking meters and, in particular, to use of system data in such systems.

### BACKGROUND ART

A parking meter system is used to achieve rationing of increasingly scarce parking spaces, and to ensure that motorists do not overstay the allowed time. Many cities have adopted multi-bay parking meters, where a multi-bay parking meter is a meter that enables the reduction in the number of parking meters on a street by being able to control more than one parking space.

Enforcement is carried out by authorised officers, often using hand held computers or citation devices. Data entry required by the officers in order to issue citations that conform to legal requirements is repetitious and tedious. Officers run the risk of being abused by disgruntled motorists should they be present at the vehicle issuing the citation when the motorist returns.

Parking meters generate significant revenues for government, and are typically spread over large geographic areas. Councils and other Local Authorities, who typically control the parking meters, have historically experienced chronic problems in the form of cash shortages and theft, and in particular, theft in the context of collection of cash by third parties under sub-contract arrangements. A further problem relates to the need to find a suitable maintenance regime to cover what can potentially be a very large number of machines spread over a large geographic area. A specific maintenance issue of particular importance relates to the need to achieve timely replacement of batteries, in the event that such machines operate on battery power, whether this is for overall operation, or operation of critical sub-systems.

A present solution to these problems involves use of locked cash boxes which can be inserted into the parking meter. Cash collection is performed when a locked cash box, containing money, is removed by a collector, and an empty locked cash box inserted into the parking meter in place of the collected cash box. In this system, cash entered into the meter by the motorist is firstly validated by the meter to ensure that legal coinage is being used, the cash then passing into the cash box. In this manner, “loose” cash is never available to collection staff until the cash boxes arrive at an authorized, supervised counting station. The parking meter tracks cash inflow and stores audit and other data as well as downloading certain data to, a memory circuit provided for this purpose in the cash box. Cash collection data for a current collection, as well as associated audit data and certain historic data, is thus also stored in the cash box memory. This data is therefore collected when the cash box itself is collected.

A first problem with the present solution is that if a cash box is lost or stolen, the associated data is also lost. Since the now missing data is often the only way of discovering the fact that the cash box is missing, a lost or stolen cash box effectively becomes invisible and undetectable.

A second problem relates to additional data which may be stored in the parking meters themselves, but which is not downloaded into the cash boxes. If this additional data is required, for example to trace otherwise inexplicable accounting variances, or to determine whether the meter has been faulty, additional separate visits are required to the parking meters. In systems with hundreds or even thousands of meters, this is an onerous, time consuming and expensive task.

Another aspect of parking meter systems is the need for enforcement, typically performed by authorised officers from either a police force department, the council itself, or a third-party contractor. In order to ensure that car owners continue to pay for the use of parking spaces, a significant effort is required by the authorised officers in order to check that cars have not overstayed the time allowed, or that motorists who have parked vehicles have paid for their stay. This typically requires an officer to visually check the parking meter itself, or alternatively, inspect a parking ticket which has been procured by the car owner and left in the car. These tickets may be issued by a certain type of parking meter. A problem with parking meter enforcement, is the significant amount of effort involved.

Another aspect of parking meter system enforcement is the fact that cited motorists will often contest a citation, stating that the relevant parking meter was out of order at the time, and that consequently, the citation should be cancelled. Enforcement officers typically have few effective means of verifying whether a meter was in fact working or out of order at that time. It is not acceptable for an officer to testify in court that a meter was working if he or she is unable to verify this as a fact.

As noted, another problem relating to parking meter systems, is the fact that a city administration can have many hundreds of parking meters within its jurisdiction, these parking meters relying on battery power derived from individual batteries in each parking meter. Reliable operation of the parking meters requires that these batteries contain sufficient charge to ensure reliable operation of all associated electronic equipment in the parking meter. Traditionally, this has been addressed by regularly replacing batteries, without direct reference to the particular battery condition of each given battery. Accordingly, while this type of periodic replacement policy does, if performed sufficiently often, ensure reliability, there is typically a significant degree of waste involved, since batteries which have sufficient charge remaining to provide additional services, are nonetheless discarded in order to simplify maintenance procedures by avoiding individual checking of each parking meter on an individual basis. Another problem associated with this type of approach, is that discarded batteries have an environmental impact, which is aggravated to the extent that otherwise operational batteries are unnecessarily discarded.

### DISCLOSURE OF THE INVENTION

It is an object of the present invention to substantially overcome, or at least ameliorate, one or more disadvantages of existing arrangements.

According to a first aspect of the invention, there is provided a method of reconstructing information in a parking meter system comprising a first plurality of cash boxes and a second plurality of parking meters, wherein a number of the first plurality of cash boxes are periodically and substantially randomly (i) mated with the corresponding number of the second plurality of parking meters for a collection period, and subsequently (ii) collected from said corresponding number of parking meters, the method comprising, for a current collection period, the steps of:

reading, from a memory store in a first collected cash box, data comprising (i) a parking meter specific collection sequence identifier which is updated each time a cash box is mated with a corresponding parking meter, (ii) a meter identifier for the corresponding meter from which the first collected cash box has been collected, (iii) current audit data for cash collected in the first collected cash box during the current collection period, and (iv) historic audit data for cash collected by said corresponding meter in a number of previous collection periods;

storing the data in a system memory store;

comparing the collection sequence identifier with preceding collection sequence identifiers for the corresponding parking meter, the previous collection sequence identifiers having been stored in the system memory store; and

reconstructing audit data associated with a missing collection sequence number preceding the collection sequence number, said reconstruction being dependent upon historic audit data stored in the system memory store, wherein said audit data associated with the missing collection sequence number includes data indicating cash collected in the corresponding parking meter during a collection period associated with the missing collection sequence number.

According to another aspect of the invention, there is provided a method of reconstructing information in a parking meter system comprising a first plurality of cash boxes and a second plurality of parking meters, wherein a number of the first plurality of cash boxes are periodically and substantially randomly (i) mated with the corresponding number of the second plurality of parking meters for a collection period, and subsequently (ii) collected from said corresponding number of parking meters, the method comprising, for a current collection period, the steps of:

reading, from a memory store in a first collected cash box, data comprising (i) a meter identifier for the corresponding meter from which the first collected cash box has been collected, (iv) current audit data for cash collected in the first collected cash box during the current collection period, and (iii) historic audit data for cash collected by said corresponding meter in a number of previous collection periods;

determining, for said corresponding meter (i) a substantially collection specific current signature dependent upon the current audit data, and (ii) substantially collection specific historic signatures dependent upon the historic audit data;

comparing the historic signatures to current signatures, which have been stored in the system memory, for preceding collection periods for the corresponding parking meter; and

reconstructing audit data associated with a missing signature associated with one of said preceding collection periods dependent upon historic audit data stored in the system memory store, wherein said audit data associated with the missing signature includes data indicating cash collected in the corresponding parking meter during a collection period associated with the missing signature.

According to another aspect of the invention, there is provided a method of establishing validity of a parking citation in a parking meter system comprising a first plurality of cash boxes and a second plurality of parking meters, wherein a number of the first plurality of cash boxes are mated periodically with the corresponding number of parking meters for a collection period, the method comprising, for a current collection period, the steps of:

collecting the cash boxes at the conclusion of the current collection period;

reading, from a memory store in a first collected cash box, first data comprising a meter identifier, and operational data for the corresponding meter from which the first collected cash box has been collected;

receiving citation information for a vehicle, having allegedly been illegally parked, during a contested time in the current collection period, in a parking spot policed by the corresponding meter from which the first collected cash box has been collected, said citation information defining the contested period;

correlating the meter identifier, said first data and said citation information to thereby establish whether said corresponding meter was operative during the contested period; and

confirming validity of the citation if the corresponding meter was operative during the contested period.

According to another aspect of the invention, there is provided a method of establishing operational status of a parking meter at the time a citation is issued, in a parking meter system comprising a first plurality of cash boxes and a second plurality of parking meters, wherein a number of the first plurality of cash boxes are periodically (i) mated with the corresponding number of the second plurality of parking meters for a collection period, and subsequently (ii) collected from the corresponding number of parking meters, the method comprising, for a current collection period, the steps of:

reading, from a memory store in a first cash box collected at the conclusion of the current collection period, a meter identifier and operational data for the corresponding meter from which the first cash box has been collected;

receiving information for the citation for a vehicle having allegedly been illegally parked at the time the citation issued, in a parking spot policed by the corresponding meter from which the first collected cash box has been collected;

correlating the meter identifier, the operational information and said: citation information to thereby establish whether said corresponding meter was operative when the citation issued; and

confirming validity of the citation if the corresponding meter was operative when said citation issued.

According to another aspect of the invention, there is provided a method of establishing a maintenance schedule for a parking meter system comprising a first plurality of cash boxes and a second plurality of parking meters, wherein a number of the cash boxes are mated periodically with the corresponding number of parking meters for a collection period, the method comprising, for a current collection period, the steps of:

collecting at least some of the number of cash boxes at the conclusion of the current collection period;

reading, from memory stores in said at least some cash boxes first data comprising associated meter identifiers, and operational data for the corresponding meters from which cash boxes have been collected; and

deriving at least one of service and maintenance requirement data for the corresponding plurality of parking meters dependent upon said first data.

According to another aspect of the invention, there is provided a parking meter system comprising a first plurality of cash boxes and a second plurality of parking meters, wherein a number of cash boxes are, periodically and substantially randomly, (i) mated with the corresponding number of parking meters for a collection period, and subsequently (ii) collected from said corresponding number of parking meters, the system further comprising:

reading means for reading, from a memory store in a first cash box collected at the conclusion of a current collection period, data comprising (i) a parking meter specific collection sequence identifier which is updated each time a cash box is mated with a corresponding parking meter, (ii) a meter identifier for the corresponding meter from which the first collected cash box has been collected, (iii) current audit data for cash collected in the first collected cash box during the current collection period, and (iv) historic audit data for cash collected by said corresponding meter in a number of previous collection periods;

system storing means for storing the data in a system memory store;

comparing means for comparing the collection sequence identifier with an immediately preceding collection sequence identifier for the corresponding parking meter, the immediately preceding collection sequence identifier having been stored in the system memory store;

alerting means for providing an alert if the collection sequence identifier is not consecutive to the immediately preceding collection sequence identifier; and

reconstructing means for reconstructing audit data associated with a missing collection sequence number falling between the collection sequence number and the immediately preceding collection sequence number, said reconstruction being dependent upon historic audit data stored in the system memory store, wherein said audit data associated with the missing collection sequence number includes data indicating cash collected in the corresponding parking meter during a collection period associated with the missing collection sequence number.

According to another aspect of the invention, there is provided a parking meter system comprising:

a first plurality of insertable cash boxes, each storing therein a cash box identity, a number of said cash boxes being substantially randomly and periodically (i) mated with a corresponding number of parking meter for a collection period, and subsequently (ii) collected from said corresponding number of parking meters;

said corresponding number of parking meters, each being adapted to acquire and store information including at least some of (i) current audit data for a present collection period, (ii) historic summary audit data for previous Collection periods, (iii) collection sequence identifiers associated with said collection periods, (iv) a machine identifier, (v) a machine transaction log, (vi) a machine performance parameter log, and (vii) a machine utilisation data log; each said parking meter being further adapted to communicate at least part of said information to a corresponding mated cash box; and

an audit system adapted to receive said at least part of said information from each of said plurality of cash boxes each time said cash boxes are collected from corresponding parking meter; wherein the audit system is adapted to reconstruct lost information stored in a missing one of said plurality of cash boxes on the basis of information received from other of said plurality of cash boxes after a following collection from the parking meter which suffered a lost cash box.

According to another aspect of the invention, there is provided a parking meter system comprising a first plurality of cash boxes and a second plurality of parking meters, wherein a number of the cash boxes are periodically mated with the corresponding number of parking meters for a collection period, and subsequently collected from said corresponding number of parking meters, the system further comprising:

reading means for reading, from a memory store in a first cash box collected at the conclusion of the current collection period, first data comprising a meter identifier, and operational data for the corresponding meter from which the first collected cash box has been collected;

citation means for receiving citation information for a vehicle, having allegedly been illegally parked, during a contested time in the current collection period, in a parking space policed by the corresponding meter from which the first collected cash box has been collected, said citation information defining the contested period; and

correlating means for correlating the meter identifier, said first data and said citation information to thereby establish whether said corresponding meter was operative during the contested period; and

confirming means for confirming validity of the citation if the corresponding meter was operative during the contested period.

According to another aspect of the invention, there is provided a parking meter system comprising:

a plurality of insertable cash boxes, each storing therein a cash box identity, said cash boxes being substantially randomly and periodically (i) mated with a corresponding plurality of parking meters for a collection period, and subsequently (ii) collected from said corresponding plurality of parking meters;

said corresponding plurality of parking meters, each being adapted to acquire and store information including at least some of (i) current audit data for a present collection period, (ii) historic summary audit data for previous collection periods, (iii) collection sequence identifiers associated with said collection periods, (iv) a machine identifier, (v) a machine transaction log, (vi) a machine performance parameter log, and (vii) a machine utilisation data log; each said parking meters being further adapted to communicate at least part of said information to a corresponding mated cash box;

an audit system adapted to receive said at least part of said information from each of said plurality of cash boxes each time said cash boxes are collected from corresponding parking meters;

a citation system adapted to receive information from a citation comprising, for a particular parked vehicle, (i) a parking legality status, (ii) at least one of a geographical location of a corresponding parking meter, a date and a time at which said parked vehicle was parked; and (iii) at least one of a registration number, a vehicle colour, and a manufacturer for said vehicle; and

an enforcement management system adapted to correlate information from (i) said audit system, and (ii) the citation system, thereby establishing whether said meter was inoperative when the citation was made.

According to another aspect of the invention, there is provided a parking meter system comprising a plurality of cash boxes and a corresponding plurality of parking meters, wherein the cash boxes are periodically mated with the corresponding plurality of parking meters for a collection period, and subsequently collected from said corresponding plurality of parking meters, the system further comprising:

reading means for reading, from memory stores in at least some of the plurality of cash boxes after collection, first data comprising associated meter identifiers, and operational data for the corresponding meters from which cash boxes have been collected; and

deriving means for deriving at least one of service and maintenance requirement data for at least some of the corresponding plurality of parking meters dependent upon said first data.

According to another aspect of the invention, there is provided a parking meter system comprising:

a plurality of insertable cash boxes, each storing therein a cash box identity, said cash boxes being substantially randomly and periodically (i) mated with a corresponding plurality of parking meter for a collection period, and subsequently (ii) collected from said corresponding plurality of parking meter;

said corresponding plurality of parking meter, each being adapted to acquire and store information including at least some of (i) current audit data for a present collection period, (ii) historic summary audit data for previous collection periods, (iii) collection sequence identifiers associated with said collection periods, (iv) a parking meter identifier, (v) a parking meter transaction log, (vi) a parking meter performance parameter log, and (vii) a parking meter utilisation data log; each said parking meter being further adapted to communicate at least part of said information to a corresponding mated cash box; and

an audit system adapted to receive said at least part of said information from each of said plurality of cash boxes each time said cash boxes are collected from corresponding parking meter; wherein said audit system further comprises:

a performance management sub-system adapted to receive and analyse said part of said information, thereby deriving one of service and maintenance requirement data for the plurality of parking meters.

According to another aspect of the invention, there is provided a parking meter system comprising:

a plurality of insertable cash boxes, each storing therein a cash box identity, said cash boxes being substantially randomly and periodically (i) mated with a corresponding plurality of parking meters for a collection period, and subsequently (ii) collected from said corresponding plurality of parking meters;

said corresponding plurality of parking meters, each being adapted to acquire and store information including at least some of (i) current audit data for a present collection period, (ii) historic summary audit data for previous collection periods, (iii) collection sequence identifiers associated with said collection periods, (iv) a machine identifier, (v) a machine transaction log, (vi) a machine performance parameter log, and (vii) a machine utilisation data log; each said parking meters being further adapted to communicate at least part of said information to a corresponding mated cash box;

a performance management sub-system adapted to receive and analyse said part of said information from each of said plurality of cash, boxes each time said cash boxes are collected from corresponding parking meters, thereby deriving one of service and maintenance requirement data for the plurality of parking meters.

According to another aspect of the invention, there is provided a parking meter system comprising:

a plurality of insertable cash boxes, each storing therein a cash box identity, said cash boxes being substantially randomly and periodically (i) mated with a corresponding plurality of parking meter for a collection period, and subsequently (ii) collected from said corresponding plurality of parking meter;

said corresponding plurality of parking meter, each being adapted to acquire and store information including at least some of (i) current audit data for a present collection period, (ii) historic summary audit data for previous collection periods, (iii) collection sequence identifiers associated with said collection periods, (iv) a parking meter identifier, (v) a parking meter transaction log, (vi) a parking meter performance parameter log, and (vii) a parking meter utilisation data log; each said parking meter being further adapted to communicate at least part of said information to a corresponding mated cash box; and

an audit system adapted to receive said at least part of said information from each of said plurality of cash boxes each time said cash boxes are collected from corresponding parking meter; wherein:

each of said plurality of parking meters is further adapted to (i) support communication established between the parking meter and a service terminal, said service terminal being used by a service technician, and (ii) to store a record of establishment of each said communication in a mated cash box; and

said audit system further comprises a service technician performance assessment sub-system adapted to receive each said record, and to correlate said at least part of said information and each said record against comparative information in a historic database, to thereby determine a performance of the service technician.

According to another aspect of the invention, there is provided a multi-bay parking meter system comprising:

a plurality of multi-bay parking meters, each said parking meter being (i) associated with a number of parking bays, and (ii) adapted to download first and second information to a portable enforcement terminal, said first information relating to a parking status for vehicles parked in said associated parking bays, and said second information relating to contextual information about the parking meter and parking parameters; and

said at least one enforcement terminal being adapted to receive said first and second information, and further adapted to receive a user input, and to output an enforcement citation dependent upon at least one of the user input, the first information and the second information.

According to another aspect of the invention, there is provided a multi-bay parking meter system comprising:

a plurality of multi-bay parking meters, each said parking meter being (i) associated with a number of parking bays and (ii) adapted to store and communicate information relating to a duration of stay for vehicles parked in each of said associated parking bays, to a portable enforcement terminal;

a central database adapted to store contextual information for said each parking meter; and

said portable enforcement terminal device which is adapted:

(i) to communicate with the central database to thereby receive the contextual information;

(ii) to communicate with said each parking meter, thereby to receive said information relating To the duration of stay for parking bays associated with said each parking meter;

(iii) to receive a first input relating to a vehicle identifier for a vehicle which is allegedly illegally parked in one of said associated parking bays; and

(iv) to output an enforcement citation dependent upon the first input and the contextual information for said each parking meter.

According to another aspect of the invention, there is provided a parking meter in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the parking meter comprising:

parking meter storage means for storing by each parking meter (i) current information relating to a current collection period and (ii) historic information relating to a number of previous collection periods into each cash box which is successively mated with said each parking meter.

According to another aspect of the invention, there is provided an insertable cash box adapted to mate with a parking meter in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the cash box comprising:

storage means for storing from each parking meter to which the cash box is successively mated (i) current information relating to a current collection period and (ii) historic information relating to a number of previous collection periods.

According to another aspect of the invention, there is provided a method of robustly storing parking meter information in a parking meter system comprising a first plurality of cash boxes and a second plurality of parking meters, wherein a number of cash boxes are periodically and substantially randomly, (i) mated with a corresponding number of parking meters for a collection period, and (ii) subsequently collected from said corresponding plurality of parking meters, the method comprising the steps of:

storing by each parking meter (i) current information relating to a current collection period and (ii) historic information relating to a number of previous collection periods into each cash box which is successively mated with said each parking meter;

retrieving information carried by said each cash box after removal of said each cash box from a corresponding parking meter; and

storing said all information into a system data store, thereby to perform repetitive and thus robust storage of individual information records.

According to another aspect of the invention, there is provided a system adapted for robust storage of parking meter information in a parking meter system comprising a first plurality of cash boxes and a second plurality of parking meters, wherein a number of cash boxes are periodically and substantially randomly, (i) mated with a corresponding number of parking meters for a collection period, and (ii) subsequently collected from said corresponding number of parking meters, the system comprising:

parking meter storage means for storing by each parking meter (i) current information relating to a current collection period and (ii) historic information relating to a number of previous collection periods into each cash box which is successively mated with said each parking meter;

retrieval means for retrieving information carried by said each cash box after removal of said each cash box from a corresponding parking meter; and

storage means for storing said all information into a system data store, thereby to perform repetitive and thus robust storage of individual information records.

According to another aspect of the invention, there is provided a method of robustly storing parking meter information in a parking meter system comprising a first plurality of cash boxes and a second plurality of parking meters, wherein a number of the cash boxes are periodically and substantially randomly, (i) mated with a corresponding number of the second plurality of parking meters for a collection period, and (ii) subsequently collected from said corresponding number of parking meters, the method comprising, for a representative one of the number of parking meters, the steps of:

storing by the representative parking meter information, comprising individual information records, relating to both a current collection period and a number of previous collection periods, into each cash box which is successively mated with said representative parking meter;

retrieving information carried by said each cash box after removal of said each cash box from the representative parking meter; and

storing said information into a system data store, thereby to perform repetitive and thus robust storage of said individual information records.

According to another aspect of the invention, there is provided a system adapted for robustly storing parking meter information in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the system comprising:

first storing means for storing by each parking meter information, comprising individual information records, relating to both a current collection period and a number of previous collection periods into each cash box which is successively mated with said each parking meter;

retrieving means for retrieving information carried by said each cash box after removal of said each cash box from a corresponding parking meter; and

second storing means for storing said information into a system data store, thereby to perform repetitive and thus robust storage of said individual information records.

According to another aspect of the invention, there is provided a method of establishing validity of a parking citation, for a vehicle which was allegedly illegally parked during a collection period, in a parking meter system comprising at least a cash box and a parking meter to which the cash box can be mated for the collection period, the method comprising the steps of:

reading, from a memory store in the cash box which has been collected at the conclusion of the collection period, data from the parking meter; and

correlating the data to the parking citation to thereby establish whether said parking meter was operative during the current collection period.

According to another aspect of the invention, there is provided a system adapted for establishing validity of a parking citation, for a vehicle which was allegedly illegally parked during a collection period, in a parking meter system comprising at least a cash box and a parking meter to which the cash box can be mated for the collection period, the system comprising:

reading means for reading, from a memory store in the cash box which has been collected at the conclusion of the collection period, data from the parking meter; and

correlating means for correlating the data to the parking citation to thereby establish whether said parking meter was operative during the current collection period.

According to another aspect of the invention, there is provided a method of establishing a maintenance schedule for a parking meter system comprising at least a cash box and a corresponding parking meter to which the cash box can be mated for a collection period, the method comprising the steps of:

reading, from a memory store in the cash box, which has been collected from the parking meter, operational data for the parking meter; and

deriving at least one of service and maintenance data for the parking meter dependent upon said operational data.

According to another aspect of the invention, there is provided a system adapted for establishing a maintenance schedule for a parking meter system comprising at least a cash box and a corresponding parking meter to which the cash box can be mated for a collection period, the system comprising:

reading means for reading, from a memory store in the cash box, which has been collected from the parking meter, operational data for the parking meter; and

deriving means for deriving at least one of service and maintenance data for the parking meter dependent upon said operational data.

According to another aspect of the invention, there is provided a multi-bay parking meter system comprising:

at least one multi-bay parking meter adapted to communicate first and second information to a portable terminal device, said first information relating to a parked vehicle, and said second information relating to contextual information about the parking meter; and

at least one portable terminal device responsive to the communication, and further adapted to receive a user input, and to output an enforcement citation dependent upon the user input, the first information and the second information.

According to another aspect of the invention, there is provided a multi-bay parking meter system comprising:

a plurality of multi-bay parking meters, each said parking meter being (i) associated with a number of parking bays and (ii) adapted to store information relating to vehicles parked in said parking bays;

a central database adapted to store contextual information for said plurality of multi-bay parking meters; and

said portable terminal device being adapted:

(i) to communicate with the central database to thereby receive the contextual information;

(ii) to communicate with one of said multi-bay parking meters, thereby to receive information for vehicles parked in corresponding parking bays; and

(iii) to output an enforcement citation for a vehicle which is illegally parked in one of said parking bays dependent upon corresponding contextual information for the designated parking meter.

### BRIEF DESCRIPTION OF THE DRAWINGS

A number of preferred embodiments of the present invention will now be described with reference to the drawings, in which:

FIG. 1 is a block diagram representation of an arrangement of a parking meter system.

FIG. 2 illustrates a typical scope of data stored in the cash box of FIG. 1;

FIG. 3 presents a process flow from the perspective of the cash box in FIG. 1;

FIG. 4 presents a process flow from the perspective of the meter in FIG. 1;

FIG. 5 presents a process flow from the perspective of the audit system in FIG. 1;

FIG. 6 depicts audit system records according to the arrangement;

FIG. 7 depicts a transaction flow diagram for a “cashless” arrangement.

FIG. 8 illustrates enforcement of multi-bay parking spaces according to a second arrangement of the parking meter system; and

FIG. 9 depicts an arrangement of an enforcement system according to FIG. 8.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

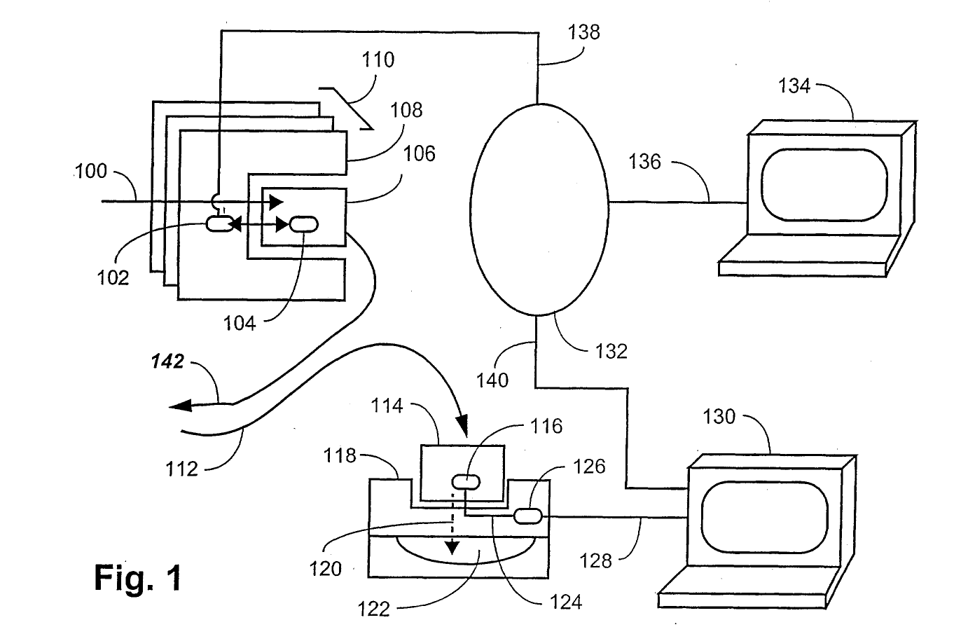

FIG. 1 shows a block diagram representation of a preferred arrangement of the parking meter system. An insertable, and locked, cash box 106 is shown inserted into a parking meter 108 the parking meter being one of a set of parking meters 110. The cash box is inserted into the meter at the start of a collection period, this being the time interval between insertion of the cash box 106 into the meter 108, and its withdrawal for cash collection. Cash is inserted into the meter 108 as depicted by an arrow 100. The cash is validated, and then passes into the cash box 106. The meter 108 incorporates a processor 102 which communicates with a processor 104 in the cash box 106.

As noted, data relating to cash box contents can be stored in a memory circuit provided for this purpose in the cash box. If, however, a broader perspective is taken with respect to the cash box and its relationship to the parking meter, an unexpected conclusion is that the cash box can be used as a general purpose data carrier, for data which is unrelated to the specific issue of the cash which has been collected. Since the cash box is periodically collected and taken to a central point (as will be described in more detail), use of the cash box as a data carrier offers a potential for a wide variety of non-cash related data processing.

Returning to FIG. 1, at the next collection, the cash box 106 is removed from the meter 108 by a collector, and replaced by an empty cash box. For the sake of explanation with reference to FIG. 1, the cash box and its internal processor are referred to by the reference numerals 106 and 104 respectively when the box is inserted into the parking meter 108. The same cash box and internal processor are referred to by the reference numerals 114 and 116 when the box is inserted into the cash box reader 118.

The collector takes the extracted cash box 106 to a counting station (not shown), as depicted by a wavy arrow 142 where the box is unlocked, and the cash counted. The counting can be either manual, or automatic using a cash counting device. Whichever method of counting is used, a counted cash total is associated with the cash box.

The extracted cash box, now designated 114 in FIG. 1, is taken by the collector, as shown by an undulating line 112, to a cash box reader 118 to which the cash box is mated. The cash box reader 118 has an on-board processor 126 which communicates with the cash box processor 116. The cash box reader processor 126 also communicates with a controller 130, and associated software (not shown) in the controller 130.

An audit system 134 can communicate with the parking meter 108 and with the controller 130 over a network 132. Alternatively, data can be exchanged between the controller 130 and the audit system 134 using floppy disk data transfer, email or any other data transfer medium.

The parking meter 108 should preferably be registered on the controller 130 and on the audit system 134, before the cash box reader 118 and the cash box 114 from the parking meter 108 are placed into communication with each other. Otherwise, the cash box reader 118 reads from the unregistered cashbox 114, uploads the data therefrom to the controller 130, which rejects the data from the unregistered cashbox 114. The cash box reader checks the registration of a parking meter by means of a parking meter identification number stored in the cash box processor 116.

The meter 108 had, since a previous collection, and while the cash box 106 was inserted in the meter 108, recorded the amount of cash inserted into the meter, and written this information to the on-board processor 104 in the cash box 106. The meter 108 had also written a unique identity number associated with the meter 108 into the processor 104. Date, time, collection sequence identifier and meter supply voltage were also written to the cash box on-board processor 104, as well as audit data for a number of previous collections, and meter service information. Historic audit data is thus stored across a number of cash boxes, providing robustness against loss of vital data through cash box loss or theft. Historic audit data is also preserved in non-volatile battery backed memory within the meter 108. When the cash box 114 is mated to the cash box reader 118, the reader 118 is prompted by the controller 130 via the processor 126, and the reader 118 thereupon reads the aforementioned data, including cash count information and parking meter identification number, from the cash box processor 116 by means of a data connection 124. The operator then manually enters the previously counted cash amount, whether it was counted automatically or manually, into the controller 130. The controller 130 will, if the manually entered cash amount differs from the cash count read by the cash box reader 118 from the cash box processor 104, query the operator as to whether the counted total is correct. The controller 130 does not communicate the cash count read from the cash box processor 116 to the operator, but merely queries the operator, a number of times to prevent the operator from guessing, as to the correctness of the entered cash count, should a difference be detected.

The audit software provides different security levels so that management retains control of cash collections. Cash collected from each machine is compared with system data, and any variance is highlighted. The availability of audit data, stored on the parking meters, and written across multiple cash boxes, allows performance of accurate system wide audit, even in the presence of missing or stolen cash boxes. Audit information is not revealed to those counting the coins, thereby preserving security. Audit software is configurable according to the security level of the person using the program. Those counting only have access to the counted value, which they enter into controller 130 as the contents of each box is scanned. An automatic prompt requests the operator to enter the amount of cash in the box.

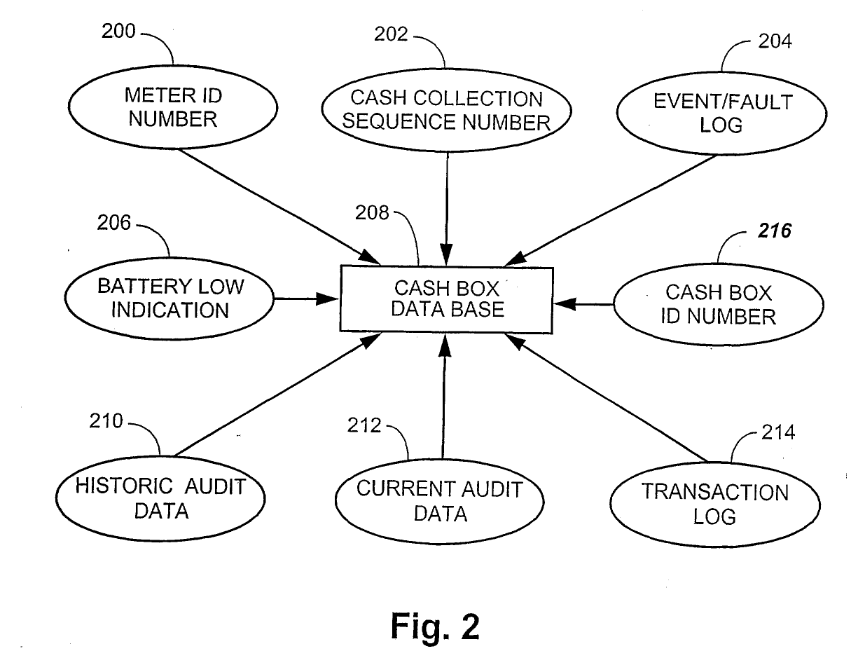

FIG. 2 shows typical data which is stored in a cash box 208. This data includes a unique cash box ID number 216, fixed for the life of the cash box, current audit data 212 for the current collection run, and historic data 210 comprising summary data for typically ten previous collection runs. A transaction log 214 can include a comprehensive log of user transactions, fault, alarm, tamper indication, maintenance events and so on, recorded by the parking meter. Cash box system performance parameters such as parking meter battery condition 206 are also stored. A parking meter identity number 200 for the meter is also stored, as well as a cash collection sequence number 202, this number being associated with each collection from a meter, and incremented by the meter with each collection. The historic audit data 210, the event/fault log 204, and the transaction log 214 operate on a “sliding window” basis, whereby when new data for the current collection run is added to the data store, the oldest data is erased, this assuming that the full memory allocation for the transaction log, event/fault log and historic audit data has been filled. The aforementioned stored system parameters can also be used for other purposes. Accordingly, the data can be used to correlate meter functional status against motorist objections such as “the meter was not working and so I should not get a parking violation citation”.

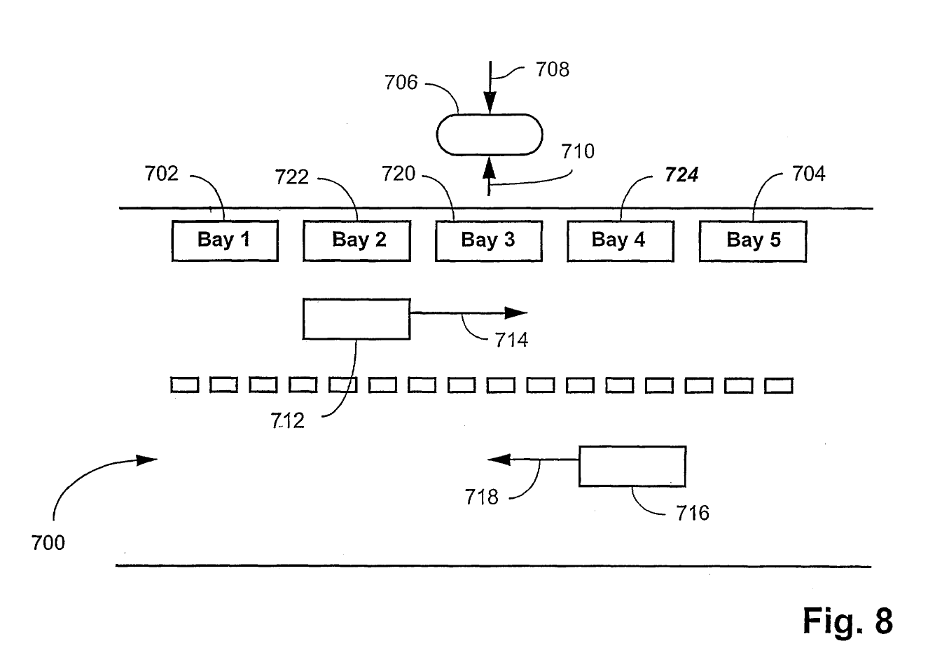

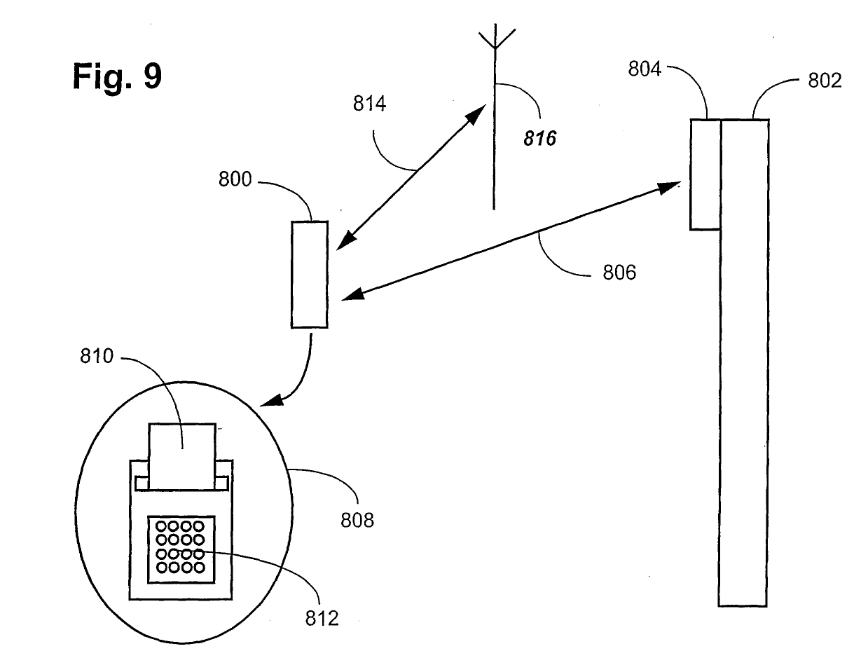

The system performance parameters and maintenance event information can be used as a basis upon which to develop maintenance schedules on a system-wide basis, and on a per-parking meter basis. Pre-emptive maintenance techniques can be used to forestall parking meters failing during operation, and wide variety of different maintenance philosophes can be supported by the aforementioned information. This information can be retrieved during the communication between the cash box 114 and the cash box reader 118 (see FIG. 1), and accordingly maintenance information can be retrieved at the same time as cash transaction information. Alternately, maintenance information can be downloaded into a hand-held enforcement device 800 (see FIG. 9), which is used by enforcement officers in the course of visiting parking meters and issuing citations. This will be explained in more detail in relation to FIGS. 8 and 9.

Considering the transaction log 214 in some detail, the log can incorporate data which relates to different functions including enforcement, maintenance, enforcement officer performance, and revenue matters. Some, or all transaction log data can be time stamped, in order to allow correlation either for a particular parking meter, across a subsection of a parking meter system, or across the entire system.

In regard to the maintenance aspect, transaction log data can provide an accurate picture of when a particular parking meter is in an operable, or alternatively, an inoperable condition. Such an inoperable condition can include either a fault situation, or alternatively, the situation in which a parking meter technician has deliberately disabled the parking meter in order to perform a maintenance operation. The provision by the parking meter of detailed information on each type of “inoperative” state enables fraud by machine technicians to be detected, allowing remedial action to be taken as required. Legitimate disabling of parking meters is to be expected, since technicians are required to change batteries on a regular basis, and also to repair faults which have reached a level which prevents reliable operation of a parking meter. On the other hand, the ability of a technician to render deliberately inoperable a parking meter, does provide an opportunity for fraudulent activity, such as provision of a “free” parking space for the technician himself, or for a friend. Deliberate disabling of a parking meter by a technician in order to perform maintenance operations is typically accompanied by allocation, by the technician, of “free credit” while he parks in the metered parking bay to perform the maintenance functions. This mechanism is used in order to ensure that a parking violation citation is not issued to the technician by a parking enforcement office who would otherwise identify a parking violation taking place. The availability of detailed performance information from the transaction log, coupled with statistical analysis of this data, enables optimal maintenance scheduling to be performed, thereby maximising the cost/benefit performance of a technician maintenance staff.

Turning to revenue matters, the transaction log can record detailed information relating to each transaction. Accordingly, the particular time of a cash infusion into the parking meter by a motorist, the functionality of the parking meter in relation to release/return of excess cash and unrecognised coins, all lend themselves to analysis of the specifics of a particular event. Since dealing with complaints from customers is a fundamental part of the business of providing self-service parking meters, availability of sufficiently detailed information is extremely useful in establishing credible and sustainable customer relations, while avoiding fraud by customers, and ensuring fairness.

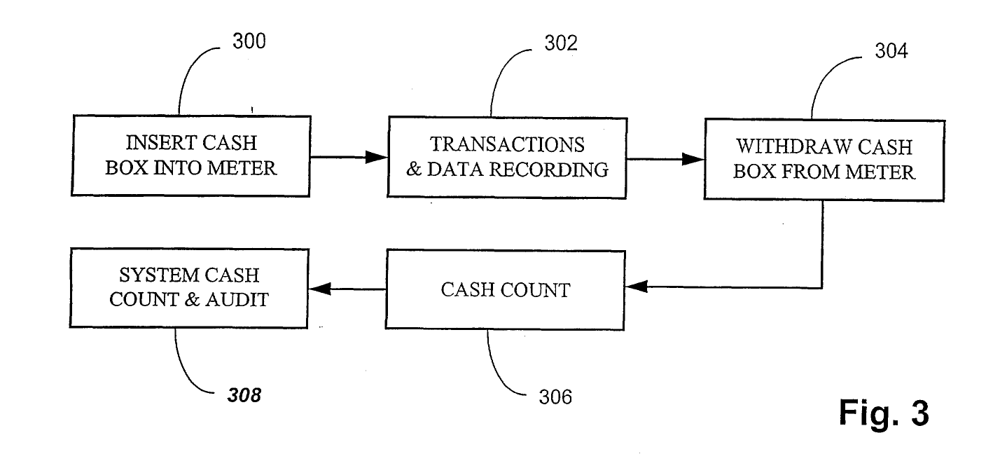

FIG. 3 shows a process flow from the perspective of the cash box, showing how the cash box is initially inserted into the meter in a step 300 at the beginning of a collection period. In a sub-process 302, user transactions relating to cash insertion are noted, and both this and other data is recorded by the parking meter which communicates associated information to the cash box. In a step 304, at the next collection run, the cash box is withdrawn, and typically another cash box is inserted (not shown). The cash box is then taken in a sub-process 306 for counting at a counting station where the cash is counted, either manually, or automatically using a cash counting machine. Thereafter, it is taken in a sub-process 308 to the cash box reader for audit and other data extraction.

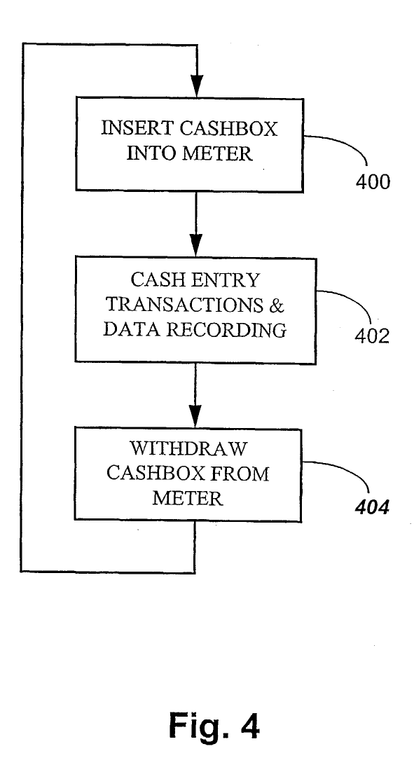

FIG. 4 presents a complimentary process flow from the perspective of the parking meter, showing the cash box being inserted in a step 400, receipt of cash and recording of transaction and other data in a sub-process 402, and withdrawal of the cash box in a step 404.

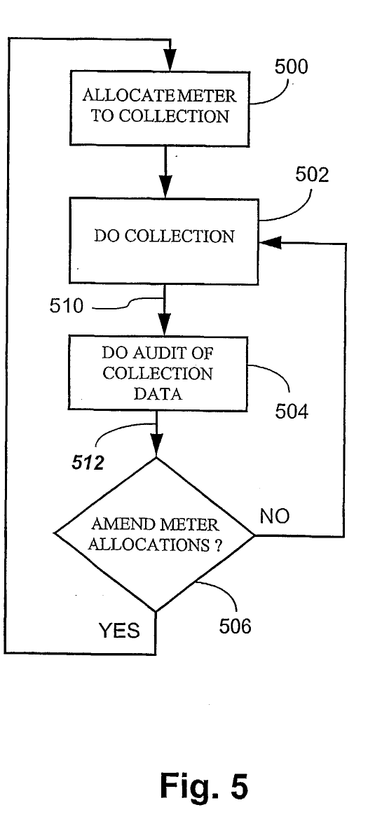

FIG. 5 shows a process flow from the perspective of the audit system, this process commencing with a sub-process 500 in which each parking meter in the system is allocated to a particular collection run. A sub-process 502 depicts “performance” of the collection, namely, encompassing the sub-processes 300, 302, and 304 in FIG. 3, and 400, 402, and 404 in FIG. 4. A sub-process 504 depicts the audit of collection and other data. After the audit sub-process 504, the allocation of meters to various collections can be amended as indicated by the “Yes” arrow emanating from a decision sub-process 506. Alternately, the audit system can loop back to the sub-process 502 as shown by the “No” arrow.

The audit sub-process 504 is concerned, among other issues, with detection of missing cash boxes. The cash collection sequence number 202 (see FIG. 2) is incremented for each collection, and stored in the cash box together with audit data relevant to that cash collection. The sequence number together with the parking meter identifying number 200 form a unique serial number for each collection. Another unique number may be formed without a sequence number, by the concatenation of certain of the data generated by the system in order to create a unique ‘signature’ for each particular collection. For the purposes of this description, the sequence number is utilised, although the historic data reconstruction is not limited to this method. An audit system database 208 archives this data. If there is, in the case of certain parking meters, an expectation of cash collections at certain user defined intervals, alarms can be generated after the expiry of such user defined time intervals if the expected collections do not occur. The audit system searches each incoming cash collection, and when an out of sequence, or missing, cash collection is detected, audit/database interaction is such that an alarm is generated. Furthermore, if cash actually collected falls below an expected collection amount, an alarm is, similarly, generated. Data associated with any missing collections is available for viewing or printout. The alarm can also trigger a warning automatically on Management and Collection computers whenever the program is run, and an out of sequence or missing collection is detected.

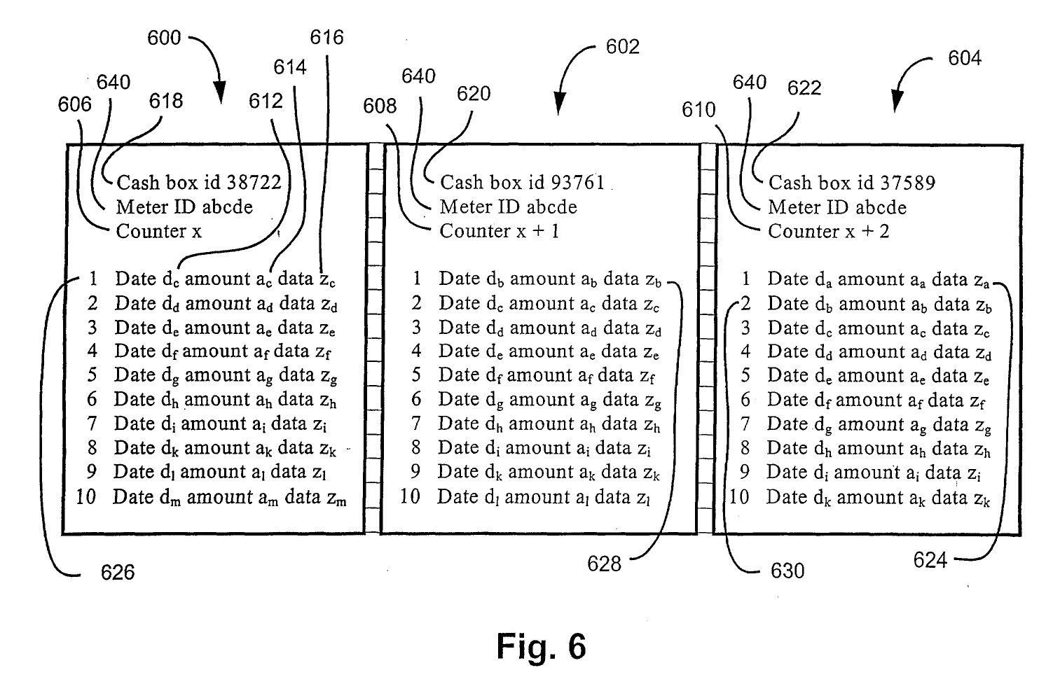

FIG. 6 depicts exemplary data generated in respect to three consecutive cash collections, the collections relating to cash boxes designated 618, 620 and. 622 respectively. Data for the first collection is represented by data set 600, data for the second by data set 602 and data for the third by data set 604. Each data set comprises an associated incremental identifier 606, 608 and 610 respectively. Furthermore, each data set comprises associated collection and system generated information (eg, in respect of the data set 600, exemplary data comprises a date d_{c} designated 612, an amount a_{c} designated 614, and other data z_{c} designated 616). After an accurate collection of cash box 618 has correctly taken place, the cash box 618 and associated money is returned to the counting office, the money is counted and the data is entered into the audit system via controller 130 and subsequently transferred to the management audit system 134. The data set 600 is stored in the audit system 134, and is associated with the parking meter having an ID “abcde” designated by a reference numeral 640. It is noted that the same reference numeral ie 640 is used to designate the “Meter ID” for all three data sets 600, 602 and 604. If, after having read the data set 600 into the audit system 134, the data set 602 is not entered into the audit system 134, perhaps as a result of cash box 620 being stolen or lost, then when the next collection (relating to cash box 622) and subsequent data entry takes place the data set 604 will be the next data set for the parking meter 640, to be entered into the audit system 134. The audit system 134 will detect that the collection sequence number 610 has been incremented twice (counter x+2) since the previous data set is 600 with sequence number 606 (counter x), and that sequence number 608 (counter x+1) is missing. The audit system 134 will then alert the system operator that a sequence anomaly has been detected. Furthermore, the audit system 134 will identify the current audit summary data 624 as registering a cash amount “aₐ”, while the previous cash entry was an amount “a_{c}”, ie the cash amount associated with the reference numeral 626. Therefore, the audit system 134 can deduce that a collection having data record 630 is missing, the missing cash box having been removed from the parking meter 604 on date “d_{b}”, to an amount of “a_{b}” (ie associated with the reference numeral 628). The “missing” data 628 is recoverable due to the storage of historic audit information on each parking meter (in this case 640), and its collection by each subsequent cash box.

The above arrangement, which is based upon availability of a unique, meter specific incremental identifier, is based upon the ability to detect a “missing” sequence number, by detecting a gap in the counter sequence x, x+1, x+2 . . . as described above.

In another arrangement, a different approach is adopted, whereby the audit data or parts of such data that each parking meter generates, and downloads to a mated cash box, is used to form a meter specific, and substantially collection specific “signature”. Alternately, the signature can be generated by the “system”, for example the controller 130.

Considering the case in which the parking meter generates the signature, if after a collection period a certain cash box is, for example, stolen after being removed from a corresponding parking meter, then the signature corresponding to that collection period (the signature constituting part of the “current” downloaded audit data in this case) will not be not be read by the cash box reader processor 126 (see FIG. 1) since the missing cash box will not be available for mating to the cash box reader 118. Accordingly, the audit data and that part of the data forming the signature will be missing from the system memory at this point.

After the following collection period, another cash box which will have been mated to that corresponding parking meter, will now contain the “missing” signature, however in this case, as part of the historic audit data. When that other cash box is mated with the cash box reader 118, the “missing” signature will now be detected; clearly indicating that the “certain” cash box has gone missing.

In the above example, a missing signature from the immediately preceding collection period is detected by comparing historic data from the specific parking meter with the data on the system for that meter and determining that one result is missing.

The substantially collection specific signature can be generated in a number of ways from the exemplary data depicted in FIG. 6. For example, the signature can be formed from a concatenation of the date d_{c} (612) and the amount a_{c} (614). Since in general, this concatenation is unlikely to recur for a given parking meter (noting that missing signature detection generally occurs during docking of cash boxes from an immediately subsequent collection period to that after which the cash box is stolen), such a signature can prove sufficient. Alternately, signatures with a lower probability of occurrence can be formed by using, for example, a longer concatenation including data z_{c} (616).

It is noted that missing signatures can be detected not only after the collection period immediately following the collection period after which the cash box went missing, but after subsequent collection periods for which the missing signature is still stored by the affected parking meter.

It is noted that each data set contains summary data, in the present arrangement, for the past ten transactions. The number of historic transactions, ie 10 transactions in the present case, has been defined for ease of description only. It will be apparent that any number of historic transactions can be stored, subject to available memory storage and the like. As new data is generated, it is stored in the system, with oldest data being removed from memory once available memory allocated to storage of historic data is full.

Instead of a cash-based system, smartcards can be used to provide a cashless arrangement of the parking meter system. Such a smartcard based system can be deployed either stand-alone, as part of a totally cashless parking system, or in conjunction with coin based operation in a hybrid system provided with cash boxes as previously described. More than one type of smartcard can be deployed concurrently, with each parking meter able to concurrently accommodate one or more types of contact-type card, in addition to one or more types of contactless card.

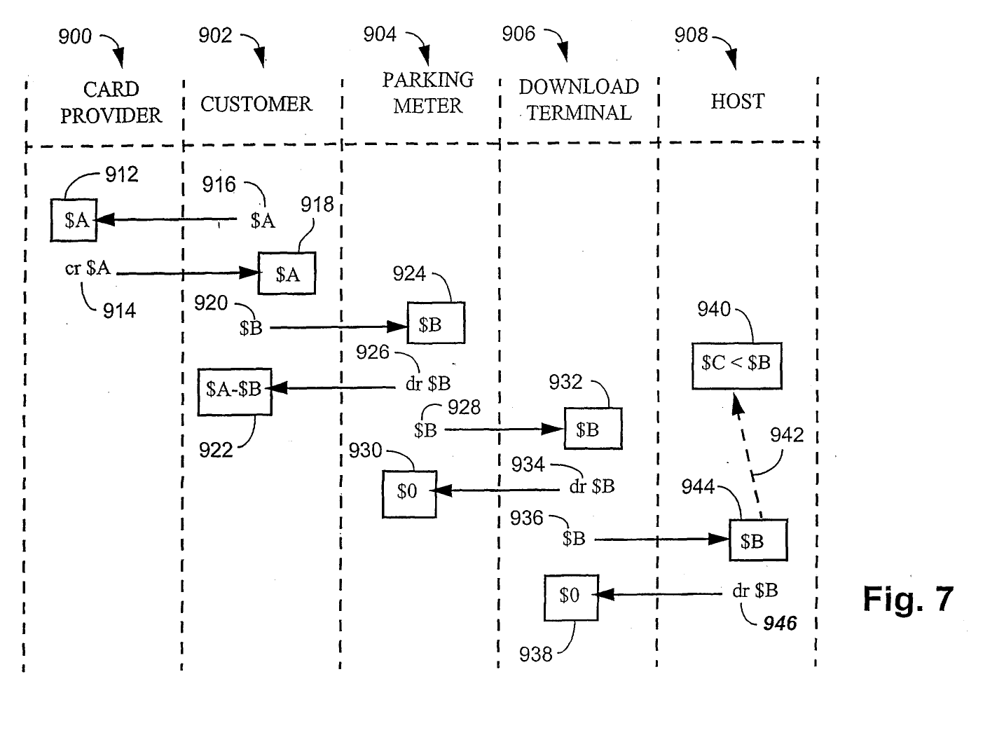

FIG. 7 depicts a conceptual transaction flow diagram in relation to such a system. The figure depicts five entities among whom transactions take place. These entities are a card provider 900, a customer 902, a parking meter 904, a download terminal 906, and a host computer 908. In a first instance, the customer 902 deposits $A (916) with the card provider 900, who consequently has a credit balance of $A (912). In the figure, dollar amounts enclosed in rectangular boxes generally denote credit balances, while dollar amounts appearing on their own represent actual cash. Thereafter, the card provider 900 credits, as depicted by a symbol “cr$A” (914), the customer 902 resulting in a credit balance 918 of $A on a smartcard held by the customer 902.

Thereafter, the customer 902 transfers $B (920) from his credit card to the parking meter 904, thereby establishing a non-cash credit balance 924 of $B in the parking meter 904. The machine 904 debits (926) $B to the smartcard held by the customer 902, thereby establishing a credit balance 922 of $A−$B (where $B<$A). In this segment of the present description, the terms “customer” 902 and “smartcard” (held by the customer) are used interchangeably. At this point, the customer 902 has paid for an initial credit balance of $A on a smartcard, and has spent $B thereof, for time in a parking space. It is noted that the credit balance 924 of $B which accumulates in the parking meter 904 represents the accumulating revenues for a provider of the service being considered.

In order for the service provider to “collect” these funds, the download terminal 906 can be used. This terminal 906 can be a special smartcard, or a device such as a laptop computer, which has a special communications interface which mimics the smartcard with which the parking meter 904 is compatible. The download terminal 906 is manually taken from one parking meter 904 to another, and establishes communications with these machines in order to upload data relating to new transactions, from the parking meter to the download terminal 906. Furthermore, the download terminal 906 downloads transaction verification information for previous transactions which have been processed to each parking meter 904 on a machine specific basis. The transaction verification download aspect relates to ensuring security of the electronic transactions. When a parking meter 904 processes a user transaction, a time stamped record of that transaction is stored in memory in the parking meter 904. This record is subsequently uploaded to the download terminal 906 when the terminal 906 next establishes communication with the parking meter 904. Following this upload, the transaction record will be maintained in memory storage by the parking meter 904, and not erased until a confirmation is received, usually as part of a download operation, the next time the download terminal 906 is connected to that parking meter 904. The aforementioned confirmation confirms that the transaction record has been conveyed to, and properly processed by, the host system (eg, the controller 130 in FIG. 1). This “end-to-end” acknowledgment process minimises the risk of lost transactions due to failures of equipment, procedures and so on. It is noted that the transaction record is conveyed to, and properly processed by the host system 908. In order to facilitate this process, each parking meter 904 has a unique electronically coded identity accessible to the download terminal 906.

In the course of the above communications, the parking meter 904 “pays” $B (928) to the download terminal 906, which consequently has a credit balance 932 of $B. The download terminal 906 debits (934) $B to the parking meter 904, which consequently, in the present instance, has a credit balance of $0 (930). At this point in the process, the revenue in the parking meter 904 has been transferred to the download terminal 906. The download terminal 906 can, thereafter, “pay” $B (936) to the host terminal 908, establishing a credit balance (944) of $B in the host machine. The download terminal 906 can connect to the host machine 908 over a network connection, which can utilise, for example, a telephone line and modem. The host 908 debits (946) $B to the download terminal 906, thereby bringing a credit balance 938 in the download terminal 906 to $0.

The aforementioned description shows how cash flows from the customer 902 to the card provider 900, and how cash transactions flow to the host 908. The service provider, which in the case of a parking meter system belongs is a council which owns and operates the parking meter system, obtains cash from the card provider 900, in acordance with the credit balance (944) of $B in the host machine 908. The card provider 900 will, in this example, pay the service provider $B, less an amount which the card provider 900 charges the service provider for various services now to be described.

Typically, the card provider 900 is commissioned by the service provider (eg. the council) to implement a complete smartcard system. This system includes issuing of cards, providing credit refills to customers holding such cards, collecting electronic cash from the parking meters 904, using and operating the download terminals 906, processing of transactions in relation to the host 908, and ultimate transfer of cash to the owner (ie. the council).

The aforementioned smartcard system is potentially opened to fraudulent activity. For example, an accountant and a programmer working for the card provider 900 can conspire to modify software running on the host 908 in such a way that the credit balance 944 of $B is incorrectly registered as $C which is less than $B (940). This fraudulent misrepresentation is depicted by a dashed arrow 942. Furthermore, the fraudulent accountant and programmer can further conspire to transfer the funds from these fraudulent transactions to a secret account, the proceeds of which are then shared among themselves. The accountant can then falsify records as necessary to ensure that the bogus account and transactions are not detected.

Without an independent means of tracking credit transactions credited to the parking meter 904, the service provider (ie. the council) will be unaware that cash due to it is being diverted. This situation is analogous to the case in a conventional cash based system, where the cash collector pilfers cash, in particular by stealing the cash box itself.

The fraudulent activity described above can be prevented by providing the parking meter 904 with an independent audit facility for logging smartcard transactions. This can be done by ensuring that the credit balance 924 of $B is stored in the parking meter 904, preferably in a time stamped-form, in a secure internal memory which is not accessible by the download terminal 906, and accordingly, inaccessible to the card provider 900. Data in the aforementioned memory can be collected by an agent commissioned by the service provider (but independent of the card provider) by a number of means. These means can include use of data transferred to the cash box, in hybrid systems where cash collection using coins is also supported. Alternatively, or in addition, enforcement officer's portable terminals (in the case of parking meter systems) can be used as a mechanism for downloading the data in the secure memory, where the enforcement officer is not on the card provider staff. Furthermore, a separate audit memory module can be installed in each parking meter, this memory module being collectable by independent contractors.

FIG. 8 illustrates another aspect of the present invention, this relating to enforcement of parking meter payments and parking bay occupancy. FIG. 8 depicts a road 700 containing five parking bays or parking spaces, these bays currently shown to contain five cars having reference numerals 702, 722, 720, 724 and 704. The corresponding parking spaces, these being associated with the multi-bay parking meter 706, are numbered Bay 1 through Bay 5. The multi-bay parking meter 706 is conveniently situated on the sidewalk. A driver of vehicle 702 can approach the multi-bay parking meter 706 as depicted by an arrow 708. The driver can then pay for the requisite time desired to park his vehicle 702 by selecting his parking space number on a: keypad (not shown) on the meter 706, and making the required payment, whereafter the driver can leave to go about his or her business. It is noted that the driver need not collect a ticket, or a record from the parking meter 706, and has no need to return to her car 702 to place the ticket in a visible location within the vehicle 702 since the parking meter 706 keeps a record of which parking bay is paid for and how much paid time remains.

The parking meter 706 can contain a display on the road-side of the parking meter 706 as depicted by an arrow 710. This display is parking-bay-specific, being easily readable by a passing vehicle 712 travelling in a direction depicted by an arrow 714, or alternately, by a vehicle 716 on the opposite side of the road 700, travelling in a direction depicted by an arrow 718. Parking enforcement officers travelling in cars or motorcycles 712 or 716 can thereby determine the display on the road side of the parking meter 706, thus identifying parking bays which have “timed out” with time thus expired. Officers on foot can also determine if the time paid for in respect of certain bays has expired. If the enforcement officer identifies that a bay has timed out, for example, the bay in which the vehicle 720 is parked, the officer can park his own vehicle, and walk over to the parking meter 706. The parking meter can be interrogated for the status of any of the parking bays it controls. Instead, however, of having to visually check the display of each parking bay's status on the parking meter 706 to determine the parking period paid for by each motorist, the enforcement officer carries a hand-held citation device (see FIG. 9 for details), which has the ability to communicate with the parking meter 706. The parking meter 706 downloads relevant data to the hand-held device, enabling the enforcement officer to verify the status of each parked car by consulting the screen on the hand held device.

When the enforcement officer issues a parking citation, statutes require that static information such as the identity of the parking meter, its physical address, the date, time and other required information including the meter's and car's geographic location be provided. Each time the officer issues a citation in this manner, the same tedious information is required. The enforcement officer can enter required data associated with a vehicle on a keypad 812 (see FIG. 9) or a touch sensitised screen(not shown).

FIG. 9 illustrates a hand-held communication device 800 engaged in communications, as depicted by an arrow 806 with a parking meter 802. The wireless communications between the citation device 800 and the parking meter 802 can utilise radio, infra-red or other communication or transmission media. A particular transmission media can be selected in accordance with emission spectra and other performance requirements on a per-market basis. Thus, for example, in certain markets a radio-based transmission arrangement would typically be used. This communication with a single parking meter 802 supports enforcement procedures for all the parking bays associated with the parking meter 802. Data downloaded by the parking meter 802 can include parking meter details such as its geographical location, as well the bay payment and remaining time status of every bay or parking space that the meter 802 controls. In order to save time in regard to entry of static information into the parking meter, the relevant data entry can be carried out when the parking meter is installed, and this typically includes, but is not limited to, the parking meter number which is usually an alphanumeric text, and which varies from council to council. A physical or street address, optional location details such as proximity to a particular building, the side of the street upon which the parking meter is located (east, west, north or south), a nearest adjacent cross street name, and so on. The processing software in the meter is able to support the aforementioned alpha-numeric data. Data entry to the parking meter can be affected using a variety of technician terminals such as a full keyboard portable machine, a palm type machine, or other equivalent user-friendly apparatus.

The automated communications function allows the relevant data to be automatically downloaded from the parking meter 802 to the citation device 800. This device 800 can, as shown in an inset 808, be equipped with the keypad 812, a touch sensitised screen (not shown) and a printer 810.

In an alternate arrangement, the parking meter contextual details such as it's geographical location, ie physical or street address, optional location details such as proximity to a particular building, the side of the street upon which the parking meter is located (east, west, north or south), a nearest adjacent cross street name, and so on, can be stored in a central database. In this system, the hand held communication devices 800 are periodically docked with a central system, thereby accessing the central database. The central database can be updated in respect to context changes on a per-multi-bay-parking meter basis, without necessitating service technician visits to each parking meter in order to update the meter memory for changed context information. Furthermore, the memory requirements in the parking meters are also thereby reduced.

In this system, parking meter enforcement officers arrive at work in the morning, and collect their individual handheld terminals which have, since the previous day, been recharged and docked with the central database, thereby updating an internal memory in the handheld terminals with the latest contextual information.

Upon arriving on duty at a particular multi-bay parking meter, the officer establishes communication with the meter, by entering, into the hand-held terminal, an identity number for the parking meter (which is visibly printed on the meter) and then either pressing an “Enter” key on the terminal keypad? or merely pointing the handheld terminal at the parking meter, which is thereby alerted to the communication establishment. The meter then downloads to the handheld terminal information on parking elapsed duration for each parking space associated with the meter. The parking elapsed duration can, for example, be of the form “25 minutes” for a bay which has been paid for and still has 25 minutes to run until the paid period elapses. Alternately, if the time paid for on another bay has elapsed 15 minutes ago, the elapsed duration data would be “−15 minutes”.

The officer would scrutinise the display on the handheld terminal to ascertain the status for each parking bay, and would go to each bay having a negative duration readout. Empty bays would elicit no action from the officer. Bays having a negative duration status and in which a car is still parked, however, would cause the officer to generate a citation.

The citation would be generated by the officer entering a vehicle identity into the terminal, along with any other information such as the specific parking regulations pertaining to the particular meter and/or the particular parking bay in which the car is illegally parked. An example of such regulations would be “No parking permitted between 9:00 AM and 5:00 PM Monday to Friday”. An example of vehicle identity would include vehicle registration, make, colour etc. Once all necessary information is entered by the officer, he or she presses a key on the terminal keypad, thereby generating a citation containing at least the vehicle description, contextual information for the meter.

In an alternate arrangement, the parking regulations can, instead of being entered by the officer, be included as part of the contextual information stored in the central database.

The capability provided to the enforcement officer by these systems obviates the need for repetitive entry of large amounts of data throughout the working day by the enforcement officer. Instead, the static data associated with the parking meter and its geography etc can be automatically downloaded, leaving the enforcement officer the relatively minor task of entering only the information associated with the particular vehicle being cited. This latter information typically includes registration number, colour, manufacturer and the like. The citation is thus quickly and efficiently issued, and can be printed by the printer 810 if statute requires this.

Further, the system allows the officer to obtain the time and parking status of more than one parking space at a time, saving time and effort.

Furthermore, the officer need not establish communications with each individual parking meter 802 as depicted by the arrow 806, but can alternately, communicate as depicted by an arrow 814 with a wide area antenna 816 by means of which data associated with a larger number of parking meters 802 in a system of such parking meters is communicated. This system-level communication enables appropriate data for all parking meters in an area to be downloaded to the hand-held device 800, making for even more rapid and productive citation activity. Furthermore, data for meters in the area can be uploaded via any one of the meters, as well as via the wide area antenna.

Further information that can be downloaded to the hand held computer 800 includes performance data and service information for the meter 802. This provides a further way of gathering the service data. Service data is stored by the hand held citation device 800 and is downloaded to a main computer system at the end of the officer's shift along with the citation information. This service and useability data is stored on a data base. Since enforcement officers are required to visit every machine the course of their duty, maintenance information associated with each machine can be downloaded to the handheld enforcement device 800, thereby providing a comprehensive process for gathering complete system maintenance data. When the citation computer 800 is docked at the end of a shift, and when the infringement notices are downloaded to the system database, the maintenance information and transaction logs can also be downloaded into a relevant database. From a maintenance perspectively, maintenance software can highlight any fault or potential fault conditions, and can generate work or service notices, with an option to direct these notices to relevant service personnel.

Should a motorist complain that a citation was issued when the meter is claimed to have been faulty, the service data can be accessed and scrutinised for verification or rebuttal of the motorist's claims. Since many Authorities currently have to cancel fines when they give the motorist the benefit of any doubt, the retrieval of this service information provides an important system of verification for the authority concerned with management of the parking.

Since citation-related data is downloaded to the system at the end of the officer's shift as noted above, a wide variety of statistical analysis can be performed on this data, both on a system wide level, and on an individual officer basis. Thus, for example, a benchmark can be established relating to the number of parking meters to be visited by an officer during the day. This benchmark can, for example, take into account a geographic distribution of the meters visited.

Further analysis can be directed towards correlating the number of parking citations issued by an officer, and the number of expired parking spaces registered during the equivalent period. Typically, parking patterns can be expected to exhibit a reasonable degree of correlation on a daily and weekly basis in a typical area equipped with parking meters. Under normal conditions, therefore, it is to be expected that a strong correlation will exist between bay occupancy, a number of parking, violations committed, and hence a number of citations which ought to be issued in this regard. If there is a significant variation between the number of citations issued by different parking officers operating under substantially similar conditions, as a proportion of the number of expired parking spaces in a particular area, then it is likely that the variation stems from the performance of the parking officer(s), where performance is measured in terms of the number of parking meters visited, diligence in issuing of citations and so on. In an extreme case, for example, a low citation issue rate could be indicative not of poor general performance, but rather of dishonesty, either taking the form of turning a “blind eye” to parking violators, or acceptance of cash to ignore transgressions.

Since enforcement officers visit parking meters as a necessary part of their duties, an unexpected benefit is derived by using these visits to also obtain other data from the parking meters. When the officers establish communication with each parking meter, primarily from the officers' perspective to obtain citation and enforcement type of information, parking meter operational data can also be downloaded to the enforcement terminal without intervention by the officer. Furthermore, the very fact that the officer must establish communication with the parking meters to perform the enforcement function, allows the parking meters to download the time and duration of these communications back to the enforcement terminal.

Accordingly, both operational data (used to validate citations, and establish maintenance schedules) and officer performance data (used to monitor enforcement officer performance) can be gathered by “piggy-backing” directly onto the officer's normal enforcement activities. This clearly provides significant labour cost savings, obviating the need for regular visits by service personnel to gather the operational data.

In addition to the function of downloading information from the parking meters to the hand-held communication device 800, the hand-held device can also be used to upload certain types of information to a parking meter. Thus, for example, if an enforcement officer notices something which raises a minor suspicion in this mind, which is nonetheless insufficient for him to take action immediately, the officer can leave a short message on a particular parking meter, this message being accessible by an enforcement officer during the later shift.

For example, towards the end of a shift, a parking officer might observe that a vehicle has been parked in a particular bay for close to the allowed maximum parking time, and the officer might surmise that the driver may have “fed” the parking meter with additional cash which would take the parking credit beyond the allowed maximum time limit. In the event that the officer making these observations is about to conclude his shift, the officer will not be able to continue observing the situation, and hence book the offender if the aforementioned violation is taking place. The messaging facility previously described would enable the officer to download a message into the parking meter, the message identifying the particular vehicle being scrutinised. This message would serve to inform the parking officer taking the next shift of duty about the suspected potential violation. The officer taking the next turn of duty is able to visit the meter, upload the message, and be able to observe the situation, serving a citation if necessary.

While a key objective of the present arrangement is to reduce time taken to issue a citation, as well as ensuring the greater degree of accuracy of citations, a subsidiary advantage of the arrangement is that efficient management of citation officers can be more easily achieved. Thus, for example, by logging on to the parking meter system as a shift progresses, an authorisation officer is effectively “clocking in” to the system. The availability of such “clocking in” data facilitates statistical analysis of enforcement officer performance. Statistical analysis can be performed in regard to the number of parking bays visited during a given period, as well as the time spent travelling a distance between one parking meter and another. It is noted, in this latter regard, that the physical distance between parking meters is known, and thus a “reasonable” time can be allocated to an enforcement officer for travelling between the meters. Excessive time spent between “clocking in” on one meter, and “clocking in” on the next meter can thus be identified, and causes therefore can be sought. A further analysis which can be performed relates to the number of expired parking bays visited during the course of a shift, as compared to the number of citations issued in that shift. Accordingly, if an enforcement officer visits parking meters controlling a total of, say, 156 expired parking spaces, but only six parking citations are issued, there is a clear need to explain the variants between expired bays and citations issued.

### INDUSTRIAL APPLICABILITY

It is apparent from the above that the invention is applicable to the self service parking meter industry.

The foregoing describes only some arrangements of the present invention, and modifications and/or changes can be made thereto without departing from the scope and spirit of the invention, the arrangements being illustrative and not restrictive.

1. A method of reconstructing information in a parking meter system comprising a first plurality of cash boxes and a second plurality of parking meters, wherein a number of the first plurality of cash boxes are periodically and substantially randomly (i) mated with the corresponding number of the second plurality of parking meters for a collection period, and subsequently (ii) collected from said corresponding number of parking meters, the method comprising, for a current collection period, the steps of:
reading, from a memory store in a first collected cash box, data comprising (i) a parking meter specific collection sequence identifier which is updated each time a cash box is mated with a corresponding parking meter, (ii) a meter identifier for the corresponding meter from which the first collected cash box has been collected, (iii) current audit data for cash collected in the first collected cash box during the current collection period, and (iv) historic audit data for cash collected by said corresponding meter in a number of previous collection periods;
storing the data in a system memory store;
comparing the collection sequence identifier with preceding collection sequence identifiers for the corresponding parking meter, the previous collection sequence identifiers having been stored in the system memory store; and
reconstructing audit data associated with a missing collection sequence number preceding the collection sequence number, said reconstruction being dependent upon historic audit data stored in the system memory store, wherein said audit data associated with the missing collection sequence number includes data indicating cash collected in the corresponding parking meter during a collection period associated with the missing collection sequence number.

2. A method of reconstructing information in a parking meter system comprising a first plurality of cash boxes and a second plurality of parking meters, wherein a number of the first plurality of cash boxes are periodically and substantially randomly (i) mated with the corresponding number of the second plurality of parking meters for a collection period, and subsequently (ii) collected from said corresponding number of parking meters, the method comprising, for a current collection period, the steps of:
reading, from a memory store in a first collected cash box, data comprising (i) a meter identifier for the corresponding meter from which the first collected cash box has been collected, (iv) current audit data for cash collected in the first collected cash box during the current collection period, and (iii) historic audit data for cash collected by said corresponding meter in a number of previous collection periods;
determining, for said corresponding meter (i) a substantially collection specific current signature dependent upon the current audit data, and (ii) substantially collection specific historic signatures dependent upon the historic audit data;
comparing the historic signatures to current signatures, which have been stored in the system memory, for preceding collection periods for the corresponding parking meter; and
reconstructing audit data associated with a missing signature associated with one of said preceding collection periods dependent upon historic audit data stored in the system memory store, wherein said audit data associated with the missing signature includes data indicating cash collected in the corresponding parking meter during a collection period associated with the missing signature.

3. A method according to claim 1, wherein the current audit data includes a current credit balance for cashless funds collected by said corresponding meter during the current collection period, the historic audit data includes historic credit balances for cashless funds collected by said corresponding meter in a number of previous collection periods, and wherein said reconstructed audit data associated with the missing collection sequence number includes data indicating a credit balance for cashless funds collected in the corresponding parking meter during a collection period associated with the missing collection sequence number.

4. A method according to claim 1, wherein a current credit balance for cashless funds collected by said corresponding meter during the current collection period, and historic audit data for historic credit balances for cashless funds collected by said corresponding meter in a number of previous collection periods, are acquired from the corresponding meter from which the first collected cash box has been collected by means of a portable data terminal capable of (i) communicating with said corresponding meter and (ii) storing the current credit balance and historic audit data for historic credit balances in the system store, and wherein said reconstructed audit data associated the missing collection sequence number includes data indicating a credit balance for cashless funds collected in the corresponding parking meter during a collection period associated with the missing collection sequence number.

5. A method of establishing validity of a parking citation in a parking meter system comprising a first plurality of cash boxes and a second plurality of parking meters, wherein a number of the first plurality of cash boxes are mated periodically with the corresponding number of parking meters for a collection period, the method comprising, for a current collection period, the steps of:
collecting the cash boxes at the conclusion of the current collection period;
reading, from a memory store in a first collected cash box, first data comprising a meter identifier, and operational data for the corresponding meter from which the first collected cash box has been collected;
receiving citation information for a vehicle, having allegedly been illegally parked, during a contested time in the current collection period, in a parking spot policed by the corresponding meter from which the first collected cash box has been collected, said citation information defining the contested period;
correlating the meter identifier, said first data and said citation information to thereby establish whether said corresponding meter was operative during the contested period; and
confirming validity of the citation if the corresponding meter was operative during the contested period.

6. A method of establishing operational status of a parking meter at the time a citation is issued, in a parking meter system comprising a first plurality of cash boxes and a second plurality of parking meters, wherein a number of the first plurality of cash boxes are periodically (i) mated with the corresponding number of the second plurality of parking meters for a collection period, and subsequently (ii) collected from the corresponding number of parking meters, the method comprising, for a current collection period, the steps of:
reading, from a memory store in a first cash box collected at the conclusion of the current collection period, a meter identifier and operational data for the corresponding meter from which the first cash box has been collected;
receiving information for the citation for a vehicle having allegedly been illegally parked at the time the citation issued, in a parking spot policed by the corresponding meter from which the first collected cash box has been collected;
correlating the meter identifier, the operational information and said citation information to thereby establish whether said corresponding meter was operative when the citation issued; and
confirming validity of the citation if the corresponding meter was operative when said citation issued.

7. A method according to claim 5, wherein:
the periodic mating of cash boxes and the corresponding plurality of parking meters is substantially random;
said first data further comprises first historic operational data for the corresponding meter from which the first cash box has been collected;
said first data is stored in a system store; and
missing information associated with a missing cash box can be reconstructed from historic information in the system store for the corresponding meter to which the missing cash box was last mated.

8. A method according to claim 5, wherein said first data is acquired from the corresponding meter from which the first collected cash box has been collected by means of at least one of (i) a portable data terminal capable of communicating with said corresponding meter, and (ii) a removable memory module in said corresponding meter.

9. A method according to claim 5, wherein the operational data comprises a meter transaction log comprising, for the current collection period:
records of times and corresponding amounts of funds fed into the corresponding meter; and
records of times and corresponding amounts of funds refunded to a customer, and unrecognised coins rejected.

10. A method according to claim 9, wherein the meter performance measures include at least one of a battery condition, a tamper indication, an operational fault, and a maintenance event.

11. A method of establishing a maintenance schedule for a parking meter system comprising a first plurality of cash boxes and a second plurality of parking meters, wherein a number of the cash boxes are mated periodically with the corresponding number of parking meters for a collection period, the method comprising, for a current collection period, the steps of:
collecting at least some of the number of cash boxes at the conclusion of the current collection period;
reading, from memory stores in said at least some cash boxes first data comprising associated meter identifiers, and operational data for the corresponding meters from which cash boxes have been collected; and
deriving at least one of service and maintenance requirement data for the corresponding plurality of parking meters dependent upon said first data.

12. A method according to claim 11, wherein said first data is acquired from the meters corresponding to said at least some of the plurality of cash boxes by means of at least one of (i) a portable data terminal capable of communicating with said corresponding meters, and (ii) removable memory modules in said corresponding meters.

13. A method according to claim 11, wherein:
the first data is stored in a system memory store for each of a plurality of collection periods; and
said at least one of service and maintenance requirement data are derived dependent upon the first data for the plurality of collection periods.

14. A parking meter system comprising a first plurality of cash boxes and a second plurality of parking meters, wherein a number of cash boxes are, periodically and substantially randomly, (i) mated with the corresponding number of parking meters for a collection period, and subsequently (ii) collected from said corresponding number of parking meters, the system further comprising:
reading means for reading, from a memory store in a first cash box collected at the conclusion of a current collection period, data comprising (i) a parking meter specific collection sequence identifier which is updated each time a cash box is mated with a corresponding parking meter, (ii) a meter identifier for the corresponding meter from which the first collected cash box has been collected, (iii) current audit data for cash collected in the first collected cash box during the current collection period, and (iv) historic audit data for cash collected by said corresponding meter in a number of previous collection periods;
system storing means for storing the data in a system memory store;
comparing means for comparing the collection sequence identifier with an immediately preceding collection sequence identifier for the corresponding parking meter, the immediately preceding collection sequence identifier having been stored in the system memory store;
alerting means for providing an alert if the collection sequence identifier is not consecutive to the immediately preceding collection sequence identifier; and
reconstructing means for reconstructing audit data associated with a missing collection sequence number falling between the collection sequence number and the immediately preceding collection sequence number, said reconstruction being dependent upon historic audit data stored in the system memory store, wherein said audit data associated with the missing collection sequence number includes data indicating cash collected in the corresponding parking meter during a collection period associated with the missing collection sequence number.

15. A parking meter system comprising:
a first plurality of insertable cash boxes, each storing therein a cash box identity, a number of said cash boxes being substantially randomly and periodically (i) mated with a corresponding number of parking meter for a collection period, and subsequently (ii) collected from said corresponding number of parking meters;
said corresponding number of parking meters, each being adapted to acquire and store information including at least some of (i) current audit data for a present collection period, (ii) historic summary audit data for previous collection periods, (iii) collection sequence identifiers associated with said collection periods, (iv) a machine identifier, (v) a machine transaction log, (vi) a machine performance parameter log, and (vii) a machine utilisation data log; each said parking meter being further adapted to communicate at least part of said information to a corresponding mated cash box; and
an audit system adapted to receive said at least part of said information from each of said plurality of cash boxes each time said cash boxes are collected from corresponding parking meter; wherein the audit system is adapted to reconstruct lost information stored in a missing one of said plurality of cash boxes on the basis of information received from other of said plurality of cash boxes after a following collection from the parking meter which suffered a lost cash box.

16. A system according to claim 15, wherein
said lost information relates to an amount of cash for a previous collection period contained in said missing cash box;
said missing cash box was collected from a specific parking meter and subsequently was one of lost and stolen prior to being coupled to the audit system; and
the lost information is reconstructed dependent upon (i) historic summary audit data from the specific parking meter, (ii) a sequence identifier associated with each said previous collection period relating to the specific parking meter, and (iii) a parking meter identifier for said specific parking meter.

17. A system according to claim 15, wherein
said lost information relates to a smartcard credit balance for a previous collection period, said balance being stored in said missing cash box;
said missing cash box was collected from a specific parking meter and subsequently was one of lost and stolen prior to being coupled to the audit system; and
the lost information is reconstructed dependent upon (i) historic summary smartcard audit data from the specific parking meter, (ii) a sequence identifier associated with each said previous collection period relating to the specific parking meter, and (iii) a parking meter identifier for said specific parking meter.

18. A system according to claim 15, wherein
each said parking meter is further adapted to communicate said at least part of said information to at least one of (i) a portable data terminal capable of communicating with said corresponding meter, and (ii) a removable memory module in said each parking meter;
said lost information relates to a smartcard credit balance for a previous collection period, said balance being stored in said at least one of (i) memory means in said each parking meter adapted for communicating with a portable data terminal, and (ii) a removable memory module in said each parking meter; and
the lost information is reconstructed dependent upon (i) historic summary smartcard audit data from the specific parking meter, (ii) a sequence identifier associated with each said previous collection period relating to the specific parking meter, and (iii) a parking meter identifier for said specific parking meter.

19. A system according to claim 15, wherein
the lost information relates to an operational status of a specific parking meter during a previous collection period, said status being stored in said parking meter performance parameter log;
said missing cash box was collected from the specific parking meter and subsequently was one of lost and stolen prior to being coupled to the audit system; and
the lost information is reconstructed dependent upon (i) a parking meter transaction log from the specific parking meter, (ii) a parking meter performance log from the specific parking meter, (iii) a sequence identifier associated with each said previous collection period relating to the specific parking meter, and (iv) a parking meter identifier for said specific parking meter.

20. A parking meter system comprising a first plurality of cash boxes and a second plurality of parking meters, wherein a number of the cash boxes are periodically mated with the corresponding number of parking meters for a collection period, and subsequently collected from said corresponding number of parking meters, the system further comprising:
reading means for reading, from a memory store in a first cash box collected at the conclusion of the current collection period, first data comprising a meter identifier, and operational data for the corresponding meter from which the first collected cash box has been collected;
citation means for receiving citation information for a vehicle, having allegedly been illegally parked, during a contested time in the current collection period, in a parking space policed by the corresponding meter from which the first collected cash box has been collected, said citation information defining the contested period; and
correlating means for correlating the meter identifier, said first data and said citation information to thereby establish whether said corresponding meter was operative during the contested period; and
confirming means for confirming validity of the citation if the corresponding meter was operative during the contested period.

21. A parking meter system comprising:
a plurality of insertable cash boxes, each storing therein a cash box identity, said cash boxes being substantially randomly and periodically (i) mated with a corresponding plurality of parking meters for a collection period, and subsequently (ii) collected from said corresponding plurality of parking meters;
said corresponding plurality of parking meters, each being adapted to acquire and store information including at least some of (i) current audit data for a present collection period, (ii) historic summary audit data for previous collection periods, (iii) collection sequence identifiers associated with said collection periods, (iv) a machine identifier, (v) a machine transaction log, (vi) a machine performance parameter log, and (vii) a machine utilisation data log; each said parking meters being further adapted to communicate at least part of said information to a corresponding mated cash box;
an audit system adapted to receive said at least part of said information from each of said plurality of cash boxes each time said cash boxes are collected from corresponding parking meters;
a citation system adapted to receive information from a citation comprising, for a particular parked vehicle, (i) a parking legality status, (ii) at least one of a geographical location of a corresponding parking meter, a date and a time at which said parked vehicle was parked; and (iii) at least one of a registration number, a vehicle colour, and a manufacturer for said vehicle; and
an enforcement management system adapted to correlate information from (i) said audit system, and (ii) the citation system, thereby establishing whether said meter was inoperative when the citation was made.

22. A parking meter system comprising a plurality of cash boxes and a corresponding plurality of parking meters, wherein the cash boxes are periodically mated with the corresponding plurality of parking meters for a collection period, and subsequently collected from said corresponding plurality of parking meters, the system further comprising:
reading means for reading, from memory stores in at least some of the plurality of cash boxes after collection, first data comprising associated meter identifiers, and operational data for the corresponding meters from which cash boxes have been collected; and
deriving means for deriving at least one of service and maintenance requirement data for at least some of the corresponding plurality of parking meters dependent upon said first data.

23. A parking meter system comprising:
a plurality of insertable cash boxes, each storing therein a cash box identity, said cash boxes being substantially randomly and periodically (i) mated with a corresponding plurality of parking meter for a collection period, and subsequently (ii) collected from said corresponding plurality of parking meter;
said corresponding plurality of parking meter, each being adapted to acquire and store information including at least some of (i) current audit data for a present collection period, (ii) historic summary audit data for previous collection periods, (iii) collection sequence identifiers associated with said collection periods, (iv) a parking meter identifier, (v) a parking meter transaction log, (vi) a parking meter performance parameter log, and (vii) a parking meter utilisation data log; each said parking meter being further adapted to communicate at least part of said information to a corresponding mated cash box; and
an audit system adapted to receive said at least part of said information from each of said plurality of cash boxes each time said cash boxes are collected from corresponding parking meter; wherein said audit system further comprises:
a performance management sub-system adapted to receive and analyse said part of said information, thereby deriving one of service and maintenance requirement data for the plurality of parking meters.

24. A parking meter system comprising:
a plurality of insertable cash boxes, each storing therein a cash box identity, said cash boxes being substantially randomly and periodically (i) mated with a corresponding plurality of parking meters for a collection period, and subsequently (ii) collected from said corresponding plurality of parking meters;
said corresponding plurality of parking meters, each being adapted to acquire and store information including at least some of (i) current audit data for a present collection period, (ii) historic summary audit data for previous collection periods, (iii) collection sequence identifiers associated with said collection periods, (iv) a machine identifier, (v) a machine transaction log, (vi) a machine performance parameter log, and (vii) a machine utilisation data log; each said parking meters being further adapted to communicate at least part of said information to a corresponding mated cash box;
a performance management sub-system adapted to receive and analyse said part of said information from each of said plurality of cash boxes each time said cash boxes are collected from corresponding parking meters, thereby deriving one of service and maintenance requirement data for the plurality of parking meters.

25. A parking meter system according to claim 24, wherein:
each said parking meter is further adapted to communicate said at least part of said information to at least one of (i) a portable data terminal capable of communicating with said parking meter, and (ii) a removable memory module in said each parking meter; and
the performance management sub-system is further adapted to receive and analyse said part of said information from said at least one of said portable data terminal, and said removable memory module, thereby deriving one of service and maintenance requirement data for the plurality of parking meters.

26. A parking meter system according to claim 24, wherein:
the machine performance parameter log comprises indicators of remaining life of meter supply batteries; and
said performance management sub-system derives a battery replacement maintenance schedule for said plurality of parking meters dependent upon said indicators.

27. A parking meter system comprising:
a plurality of insertable cash boxes, each storing therein a cash box identity, said cash boxes being substantially randomly and periodically (i) mated with a corresponding plurality of parking meter for a collection period, and subsequently (ii) collected from said corresponding plurality of parking meter;
said corresponding plurality of parking meter, each being adapted to acquire and store information including at least some of (i) current audit data for a present collection period, (ii) historic summary audit data for previous collection periods, (iii) collection sequence identifiers associated with said collection periods, (iv) a parking meter identifier, (v) a parking meter transaction log, (vi) a parking meter performance parameter log, and (vii) a parking meter utilisation data log; each said parking meter being further adapted to communicate at least part of said information to a corresponding mated cash box; and
an audit system adapted to receive said at least part of said information from each of said plurality of cash boxes each time said cash boxes are collected from corresponding parking meter; wherein:
each of said plurality of parking meters is further adapted to (i) support communication established between the parking meter and a service terminal, said service terminal being used by a service technician, and (ii) to store a record of establishment of each said communication in a mated cash box; and
said audit system further comprises a service technician performance assessment sub-system adapted to receive each said record, and to correlate said at least part of said information and each said record against comparative information in a historic database, to thereby determine a performance of the service technician.

28. A multi-bay parking meter system comprising:
a plurality of multi-bay parking meters, each said parking meter being (i) associated with a number of parking bays, and (ii) adapted to download first and second information to a portable enforcement terminal, said first information relating to a parking status for vehicles parked in said associated parking bays, and said second information relating to contextual information about the parking meter and parking parameters; and
said at least one enforcement terminal being adapted to receive said first and second information, and further adapted to receive a user input, and to output an enforcement citation dependent upon at least one of the user input, the first information and the second information.

29. The multi-bay parking meter system according to claim 28, wherein:
said each parking meter is further adapted to download, to the enforcement terminal, operational data for said each parking meter; and wherein
the system is further adapted to (i) receive information from the enforcement citation for a vehicle, having allegedly been illegally parked in a parking spot policed by said each parking meter, (ii) to correlate the citation information and the operational data to thereby establish whether said each parking meter was operative when the citation was issued, and (iii) to issue the citation if the corresponding meter was operative when the citation was issued.

30. The multi-bay parking meter system according to either of claims 28 and 29, wherein:
said each parking meter is further adapted to determine and download, to the enforcement terminal, at least one of (i) a time at which the enforcement terminal established contact with the parking meter, and (ii) a time period during which the enforcement terminal was in communication with the parking meter; and wherein
the system is further adapted to compare said at least one of the time and the time period against corresponding stored historic data to thereby establish a performance measure for an enforcement officer using the enforcement terminal.

31. The multi-bay parking meter system according to any one of claims 28 to 30, wherein:
the system is further adapted to derive maintenance data for the parking meter dependent upon said operational data.

32. A multi-bay parking meter system comprising:
a plurality of multi-bay parking meters, each said parking meter being (i) associated with a number of parking bays and (ii) adapted to store and communicate information relating to a duration of stay for vehicles parked in each of said associated parking bays, to a portable enforcement terminal;
a central database adapted to store contextual information for said each parking meter; and
said portable enforcement terminal device which is adapted:
(i) to communicate with the central, database to thereby receive the contextual information;
(ii) to communicate with said each parking meter, thereby to receive said information relating to the duration of stay for parking bays associated with said each parking meter;
(iii) to receive a first input relating to a vehicle identifier for a vehicle which is allegedly illegally parked in one of said associated parking bays; and
(iv) to output an enforcement citation dependent upon the first input and the contextual information for said each parking meter.

33. The multi-bay parking meter system according to claim 32, wherein:
said each parking meter is further adapted to download, to the enforcement terminal, operational data for said each parking meter; and wherein
the system is further adapted to (i) receive information from the enforcement citation for the allegedly illegally parked vehicle, (ii) to correlate the citation information and the operational data to thereby establish whether said each parking meter was operative when the citation was issued, and (iii) to validate the citation if the corresponding meter was operative when the citation was issued.

34. A multi-bay parking meter system according to either of claims 32 and 33, wherein:
said each parking meter is further adapted to determine and download, to the enforcement terminal, at least one of (i) a time at which the enforcement terminal established contact with said each parking meter, and (ii) a time period during which the enforcement terminal was in communication with said each parking meter; and wherein
the system is further adapted to compare said at least one of the time and the time period against corresponding stored historic data to thereby establish a performance measure for an enforcement officer using the enforcement terminal.

35. A multi-bay parking meter system according to claim 34, wherein:
said performance measure relates to productivity of the enforcement officer, said productivity being dependent upon at least one of:
an average time interval between establishing contact with successive parking meters;
an average number of expired bays discovered during communication between the officer and successive parking meters; and
an average number of citations issued per collection period.

36. The multi-bay parking meter system according to any one of claims 32 to 34, wherein:
the system is further adapted to derive maintenance data for said each parking meter dependent upon said operational data.

37. A multi-bay parking meter system according to either one of claims 28 and 32, wherein said contextual information includes at least one of a street address and a name of at least one nearest cross street.

38. A multi-bay parking meter system according to either one of claims 28 and 32, wherein said duration of stay for a vehicle parked in one of said associated parking bays represents a time remaining if the vehicle is legally parked, and a time elapsed, if the vehicle is illegally parked.

39. A multi-bay parking meter system according to either one of claims 28 and 32, wherein said second user input further comprises a statement concerning parking regulations for the one of said parking bays in which the vehicle is illegally parked.

40. A parking meter system according to claim 28, wherein the download of first and second information is performed using a direct communication link between the parking meter and the portable terminal device.

41. A parking meter system according to claim 28, further comprising:
a wide area data acquisition and communication sub-system adapted to acquire and store said first and second information associated with the one or more parking meters, and further adapted to communicate said first and second information to the one or more portable terminals; wherein the download of said first and second information is performed using a communication link between the portable terminal devices and the communication sub-system.

42. A parking meter system according to claim 28, wherein said first information relates to a parking legality status associated with the associated one or more parked vehicles.

43. A parking meter system according to claim 28, wherein said second information relates to at least one of a geographical location of said parking meter, a date and a time.

44. A parking meter system according to claim 28, wherein said user information relates to at least one of a vehicle registration number, a vehicle colour, and a vehicle manufacturer.

45. A parking meter in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the parking meter comprising:
parking meter storage means for storing by each parking meter (i) current information relating to a current collection period and (ii) historic information relating to a number of previous collection periods into each cash box which is successively mated with said each parking meter.

46. An insertable cash box adapted to mate with a parking meter in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the cash box comprising:
storage means for storing from each parking meter to which the cash box is successively mated (i) current information relating to a current collection period and (ii) historic information relating to a number of previous collection periods.

47. A method of robustly storing parking meter information in a parking meter system comprising a first plurality of cash boxes and a second plurality of parking meters, wherein a number of cash boxes are periodically and substantially randomly, (i) mated with a corresponding number of parking meters for a collection period, and (ii) subsequently collected from said corresponding plurality of parking meters, the method comprising the steps of:
storing by each parking meter (i) current information relating to a current collection period and (ii) historic information relating to a number of previous collection periods into each cash box which is successively mated with-said each parking meter;
retrieving information carried by said each cash box after removal of said each cash box from a corresponding parking meter; and
storing said all information into a system data store, thereby to perform repetitive and thus robust storage of individual information records.

48. A system adapted for robust storage of parking meter information in a parking meter system comprising a first plurality of cash boxes and a second plurality of parking meters, wherein a number of cash boxes are periodically and substantially randomly, (i) mated with a corresponding number of parking meters for a collection period, and (ii) subsequently collected from said corresponding number of parking meters, the system comprising:
parking meter storage means for storing by each parking meter (i) current information relating to a current collection period and (ii) historic information relating to a number of previous collection periods into each cash box which is successively mated with said each parking meter;
retrieval means for retrieving information carried by said each cash box after removal of said each cash box from a corresponding parking meter; and
storage means for storing said all information into a system data store, thereby to perform repetitive and thus robust storage of individual information records.

49. A method of robustly storing parking meter information in a parking meter system comprising a first plurality of cash boxes and a second plurality of parking meters, wherein a number of the cash boxes are periodically and substantially randomly, (i) mated with a corresponding number of the second plurality of parking meters for a collection period, and (ii) subsequently collected from said corresponding number of parking meters, the method comprising, for a representative one of the number of parking meters, the steps of:
storing by the representative parking meter information, comprising individual information records, relating to both a current collection period and a number of previous collection periods, into each cash box which is successively mated with said representative parking meter;
retrieving information carried by said each cash box after removal of said each cash box from the representative parking meter; and
storing said information into a system data store, thereby to perform repetitive and thus robust storage of said individual information records.

50. A system adapted for robustly storing parking meter information in a parking meter system comprising a plurality of cash boxes and a corresponding plurality of parking meters, wherein the cash boxes are periodically and substantially randomly, (i) mated with the corresponding plurality of parking meters for a collection period, and (ii) subsequently collected from said corresponding plurality of parking meters, the system comprising:
first storing means for storing by each parking meter information, comprising individual information records, relating to both a current collection period and a number of previous collection periods into each cash box which is successively mated with said each parking meter;
retrieving means for retrieving information carried by said each cash box after removal of said each cash box from a corresponding parking meter; and
second storing means for storing said information into a system data store, thereby to perform repetitive and thus robust storage of said individual information records.

51. A method of establishing validity of a parking citation, for a vehicle which was allegedly illegally parked during a collection period, in a parking meter system comprising at least a cash box and a parking meter to which the cash box can be mated for the collection period, the method comprising the steps of:
reading, from a memory store in the cash box which has been collected at the conclusion of the collection period, data from the parking meter; and
correlating the data to the parking citation to thereby establish whether said parking meter was operative during the current collection period.

52. A system adapted for establishing validity of a parking citation, for a vehicle which was allegedly illegally parked during a collection period, in a parking meter system comprising at least a cash box and a parking meter to which the cash box can be mated for the collection period, the system comprising:
reading means for reading, from a memory store in the cash box which has been collected at the conclusion of the collection period, data from the parking meter; and
correlating means for correlating the data to the parking citation to thereby establish whether said parking meter was operative during the current collection period.

53. A method of establishing a maintenance schedule for a parking meter system comprising at least a cash box and a corresponding parking meter to which the cash box can be mated for a collection period, the method comprising the steps of:
reading, from a memory store in the cash box, which has been collected from the parking meter, operational data for the parking meter; and
deriving at least one of service and maintenance data for the parking meter dependent upon said operational data.

54. A system adapted for establishing a maintenance schedule for a parking meter system comprising at least a cash box and a corresponding parking meter to which the cash box can be mated for a collection period, the system comprising:
reading means for reading, from a memory store in the cash box, which has been collected from the parking meter, operational data for the parking meter; and
deriving means for deriving at least one of service and maintenance data for the parking meter dependent upon said operational data.

55. A multi-bay parking meter system comprising:
at least one multi-bay parking meter adapted to communicate first and second information to a portable terminal device, said first information relating to a parked vehicle, and said second information relating to contextual information about the parking meter; and
at least one portable terminal device responsive to the communication, and further adapted to receive a user input, and to output an enforcement citation dependent upon the user input, the first information and the second information.

56. A multi-bay parking meter system comprising:
a plurality of multi-bay parking meters, each said parking meter being (i) associated with a number of parking bays and (ii) adapted to store information relating to vehicles parked in said parking bays;
a central database adapted to store contextual information for said plurality of multi-bay parking meters; and
said portable terminal device being adapted:
(i) to communicate with the central database to thereby receive the contextual information;
(ii) to communicate with one of said multi-bay parking meters, thereby to receive information for vehicles parked in corresponding parking bays; and
(iii) to output an enforcement citation for a vehicle which is illegally parked in one of said parking bays dependent upon corresponding contextual information for the designated parking meter.
